(19) United States
(12) Patent Application Publication
(10) Pub. No.: US 2020/0166194 A1
(43) Pub. Date: May 28, 2020

(54) DISPLAY APPARATUS HAVING DIFFUSER PLATE AND METHOD OF MANUFACTURING THE DIFFUSER PLATE

(71) Applicant: SAMSUNG ELECTRONICS CO., LTD., Suwon-si (KR)

(72) Inventors: Kil Hong Lee, Suwon-si (KR); Dae Young Kim, Suwon-si (KR); Hyung Ki Kim, Suwon-si (KR); Yong Sung Yoo, Suwon-si (KR); Duk Jin Jeon, Suwon-si (KR); Tae Hee Jeon, Suwon-si (KR)

(73) Assignee: SAMSUNG ELECTRONICS CO., LTD., Suwon-si (KR)

(21) Appl. No.: 16/692,293

(22) Filed: Nov. 22, 2019

(30) Foreign Application Priority Data
Nov. 22, 2018 (KR) 10-2018-0145204

(51) Int. Cl. F21V 3/08; G02B 5/02; F21V 8/00

(52) U.S. Cl. CPC F21V 3/08; G02B 5/0278; G02B 5/0268; G02B 6/0051; G02B 5/0215

(57) ABSTRACT

A display apparatus includes: a display panel; a light source configured to supply light to the display panel; and a diffuser plate configured to diffuse the light supplied to the display panel. The diffuser plate includes: a first diffusion layer comprising a plurality of concave portions in a first surface of the first diffusion layer; a light converter provided in each concave portion of the plurality of concave portions; and a second diffusion layer configured to cover the first surface of the first diffusion layer.

### CROSS-REFERENCE TO RELATED APPLICATION

This application is based on and claims priority under 35 U.S.C. § 119 to Korean Patent Application No. 10-2018-0145204, filed on Nov. 22, 2018 in the Korean Intellectual Property Office, the disclosure of which is incorporated by reference herein in its entirety.

### BACKGROUND

### 1. Field

The disclosure relates to a display apparatus having a diffuser plate and a method of manufacturing the diffuser plate, and more particularly, to a display apparatus having a diffuser plate with an improved structure and a method of manufacturing the diffuser plate.

### 2. Description of the Related Art

In the related art, a display apparatus is an apparatus for displaying an image or text. Examples of the display apparatus include a monitor and a television. The display apparatus may use a self-emissive display panel such as an Organic Light Emitting Diode (OLED) panel or a light-receiving display panel such as a Liquid Crystal Display (LCD) panel.

In a display module and a display apparatus to which a light-receiving display panel is applied, the display apparatus is configured with a LCD panel on which an image or text is displayed and a backlight unit for supplying light to the display panel. The backlight unit includes a light source module having a light source and a plurality of optical sheets receiving light from the light source to guide the light to the display panel. The optical sheets are configured with a reflective sheet, a light guide plate or a diffusion sheet and a prism sheet, a diffusion sheet, a polarizing sheet, etc.

Color reproducibility of the light emitted from the light source may be improved by quantum dots (QDs). Typically, such improvement of the color reproducibility has been achieved through an optical sheet including QDs positioned on the rear side of a display panel.

However, in the related art, because QDs are sensitive to temperature and oxygen, the performance of the optical sheet including the QDs may be weakened or modified when the QDs are overheated or exposed to the outside.

### SUMMARY

Therefore, it is an aspect of the disclosure to provide a display apparatus with a simple structure to manufacture.

It is another aspect of the disclosure to provide a display apparatus with an improved color reproducibility.

Additional aspects of the disclosure will be set forth in part in the description which follows and, in part, will be obvious from the description, or may be learned by practice of the disclosure.

In accordance with an aspect of the disclosure, a display apparatus includes: a display panel; a light source configured to supply light to the display panel; and a diffuser plate configured to diffuse the light supplied to the display panel. The diffuser plate may include: a first diffusion layer comprising a plurality of concave portions in a first surface of the first diffusion layer; a light converter provided in each concave portion of the plurality of concave portions; and a second diffusion layer configured to cover the first surface of the first diffusion layer.

The light converter in the plurality of concave portions may be surrounded by the first diffusion layer and the second diffusion layer.

The plurality of concave portions may include a plurality of concave surfaces, and the light converter may be sealed by the plurality of concave surfaces and a second surface of the second diffusion layer opposite to the first surface of the first diffusion layer.

The light converter may be arranged uniformly on the diffuser plate.

A material of the first diffusion layer may be identical to a material of the second diffusion layer.

The diffuser plate may correspond to a rear surface of the display panel.

The plurality of concave portions may be formed when the first surface of the first diffusion layer is pressed by a pattern roller, the pattern roller comprising a plurality of pattern protrusions formed on an outer surface of the pattern roller.

A depth of a concave portion of the plurality of concave portions may be smaller than a depth of the first diffusion layer.

Each concave surface of the plurality of concave surfaces may include at least one of a polygonal flat surface or a curved surface.

The light source may be configured to emit blue light, and the light converter may include quantum dots (QDs) configured to convert the blue light into white light.

The light source may include a plurality of light sources arranged on a plane extending parallel to a rear surface of the display panel, and the diffuser plate may be positioned between the display panel and the plurality of light sources.

The display apparatus may further include a light guide plate configured to receive the light supplied from the light source from a light receiving surface of the light guide plate and configured to emit the light through a light emitting surface,

wherein the diffuser plate is provided on an opposite side to the light emitting surface of the light guide plate.

In accordance with another aspect of the disclosure, a method of manufacturing a diffuser plate configured to diffuse light supplied from a light source to a display panel may include: extruding a first diffusion layer; forming a plurality of concave portions in a first surface of the first diffusion layer; filling a light converter in the plurality of concave portions; and extruding a second diffusion layer on the first surface of the first diffusion layer.

The plurality of concave portions may be formed when a plurality of protrusions formed on a surface of a pattern roller contact the first surface of the first diffusion layer.

When the pattern roller contacts the first surface of the first diffusion layer, a second surface opposite to the first surface of the first diffusion layer is pressed by a pressing roller.

The arranging the light converter on the plurality of concave portions may include: supplying the light converter to the first surface of the first diffusion layer; and removing the light converter remaining on the first surface of the first diffusion layer after being injected in the plurality of concave portions of the first diffusion layer.

A material of the first diffusion layer is identical to a material of the second diffusion layer.

In accordance with another aspect of the disclosure, a display apparatus includes: a display panel; a plurality of light sources arranged to correspond to a rear surface of the display panel and configured to supply light to the display panel; and a diffuser plate positioned between the display panel and the plurality of light sources and configured to diffuse the light supplied to the display panel, wherein the diffuser plate includes: a first diffusion layer and a second diffusion layer stacked on each other; and a light converter positioned between the first diffusion layer and the second diffusion layer.

The first diffusion layer may include a plurality of concave surfaces arranged in a first surface of the first diffusion layer, and the light converter is surrounded by each concave surface of the plurality of concave surfaces and the second diffusion layer.

The plurality of concave surfaces and the light converter may be arranged uniformly on the diffusion plate.

In accordance with another aspect of the disclosure, a display apparatus includes: a diffuser plate including: a first diffusion layer comprising a plurality of concave portions in a first surface of the first diffusion layer; a light converter provided in each concave portion of the plurality of concave portions; and a second diffusion layer provided on the first surface of the first diffusion layer. The plurality of concave portions are provided on a single plane.

The light converter in the plurality of concave portions is sealed by the first diffusion layer and the second diffusion layer.

A material of the first diffusion layer is identical to a material of the second diffusion layer.

The plurality of concave portions comprise a plurality of concave surfaces. Each concave surface of the plurality of concave surfaces comprises at least one of a polygonal flat surface or a curved surface

### BRIEF DESCRIPTION OF THE DRAWINGS

The above and/or other aspects of the disclosure will become apparent and more readily appreciated from the following description of the embodiments, taken in conjunction with the accompanying drawings of which:

FIG. 1 is a perspective view of a display apparatus according to an embodiment;

FIG. 2 is an exploded perspective view of a display apparatus according to an embodiment;

FIG. 3 is a cross-sectional view of a display apparatus according to an embodiment;

FIG. 4 is an enlarged cross-sectional view of a diffuser plate of an optical member 50 of a display apparatus according to an embodiment;

FIG. 5 is a perspective view of a diffuser plate of an optical member 50 of a display apparatus according to an embodiment;

FIG. 6 shows an apparatus for manufacturing a diffuser plate of a display apparatus according to an embodiment; and

FIG. 7 shows a pattern roller used in an apparatus for manufacturing a diffuser plate of a display apparatus according to an embodiment.

### DETAILED DESCRIPTION

Configurations illustrated in the embodiments and the drawings described in the disclosure are only the preferred embodiments of the disclosure, and thus it is to be understood that various modified examples, which may replace the embodiments and the drawings described in the present specification, are possible when filing the present application.

Also, like reference numerals or symbols denoted in the drawings of the present specification represent members or components that perform the substantially same functions.

The terms used in the disclosure are merely used to describe embodiments, and are not intended to limit the disclosure. An expression used in the singular encompasses the expression of the plural, unless it has a clearly different meaning in the context. In the disclosure, it is to be understood that the terms such as “comprising”, “including” or “having”, etc., are intended to indicate the existence of the features, numbers, operations, components, parts, or combinations thereof disclosed in the specification, and are not intended to preclude the possibility that one or more other features, numbers, operations, components, parts, or combinations thereof may exist or may be added.

It will be understood that, although the terms “first”, “second”, etc., may be used herein to describe various elements, these elements should not be limited by these terms. The above terms are used only to distinguish one component from another. For example, a first component discussed below in the detailed description could be termed a second component, and similarly, a second component may be termed a first component without departing from the teachings of this disclosure. As used herein, the term “and/or” includes any and all combinations of one or more of associated listed items.

Hereinafter, the embodiments of the disclosure will be described in detail with reference to the accompanying drawings.

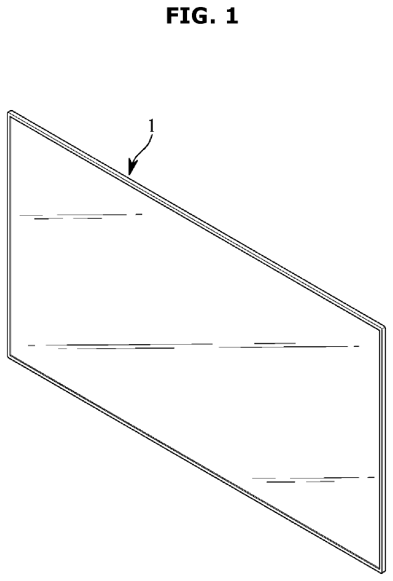

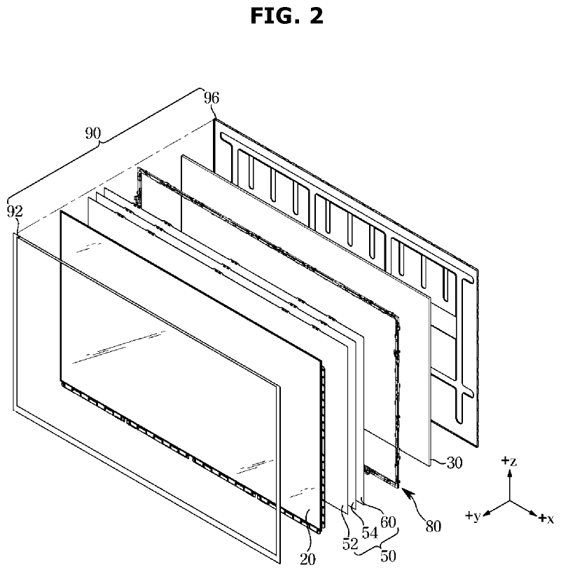

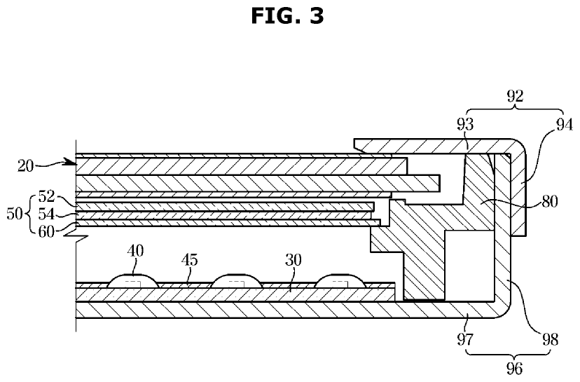

FIG. 1 is a perspective view of a display apparatus 1 according to an embodiment, FIG. 2 is an exploded perspective view of a display apparatus 1 according to an embodiment, and FIG. 3 is a cross-sectional view of a display apparatus 1 according to an embodiment.

In the embodiment of FIGS. 1-3, the display apparatus 1 is a flat display apparatus. However, it will be easily understood by one of ordinary skill in the art that the display apparatus 1 may be implemented, for example, as a curved display apparatus having a screen of a fixed curvature, a flexible display apparatus, a bent display apparatus, or a variable curvature display apparatus having a curved screen where a curvature of the screen changes according to a user input.

The display apparatus 1 may include a display module for displaying images and/or texts.

Referring to FIGS. 2 and 3, the display module of the display apparatus 1 may include a display panel 20 on which images and/or texts are displayed, a printed circuit board 30, a light source 40, and an optical member 50.

Specifically, the display apparatus 1 may include the light source 40 positioned behind the display panel 20, the optical member 50 positioned between the display panel 20 and the light source 40 to change optical properties, a middle mold 80 supporting the display panel 20, and a display chassis 90 forming an outer appearance of the display apparatus 1. The display chassis 90 may include a top chassis 92 coupled with a front portion of the middle mold 80 to maintain a state in which the display panel 20 is installed in the middle mold 80, and a bottom chassis 96 coupled with a rear portion of the middle mold 80. Here, the light source 40 may be arranged on the bottom chassis 96.

The light source 40 may be arranged on the bottom chassis 96 to radiate light toward the display panel 20. The embodiment of the disclosure is directed to a display apparatus using a direct-type display method, however, the embodiment is not limited there to. The embodiment of the disclosure may also be applied to an edge type display method. In the edge type display method, the light source 40 may be positioned along one side of a light guide plate so that light supplied from the light source 40 may be incident to a side surface of the light guide plate. The light incident to the side surface of the light guide plate may exit a light emitting surface of the light guide plate toward a rear surface of a display panel. In this case, the optical member 50 may be provided opposite to the light emitting surface of the light guide plate.

In the front portion of the middle mold 80, the display panel 20 and the top chassis 92 may be arranged such that the display panel 20 is supported by the middle mold 80 and the top chassis 92 is supported by the middle mold 80 and the display panel 20, and in the rear portion of the middle mold 80, the bottom chassis 96 may be positioned to support the individual components (e.g., the printed circuit board 30 and the middle mold 80) and maintain a state in which the display panel 20 is separated from the bottom chassis 96 via the middle mold 80.

The top chassis 92 may include a bezel portion 93 covering front edges of the display panel 20, and a top side portion 94 bent in a rear direction from the end of the bezel portion 93 to cover sides of the middle mold 80.

The bottom chassis 96 may include a rear portion 97 forming a rear surface of the display module, and a bottom side portion 98 extending in the front direction from edges of the rear portion 97 and coupled in the middle mold 80. The bottom chassis 96 may be in the shape of a polygonal plate having high strength, and include a metal material (for example, aluminum, an aluminum alloy, etc.) having low thermal deformation against heat emitted from the light source 40 and/or the display panel 20 accommodated therein. The bottom chassis 96 may be molded with a plastic material (for example, poly carbonate (PC)) or a material resulting from adding glass fiber to a plastic material.

A plurality of light sources 40 may be mounted on the printed circuit board 30. The size of the printed circuit board 30 may correspond to a size of the display panel 20. The plurality of light sources 40 may be arranged in a plurality of rows on the printed circuit board 30 (i.e., in a matrix form). The plurality of light sources 40 may be planar-arranged on the printed circuit board 30.

The reflective sheet 45 (FIG. 3) may reflect light radiated from the light source 40 toward the display panel 20, or re-reflect light reflected by the optical member 50 or the display panel 20 toward back to the display panel 20. The reflective sheet 45 may be positioned on the entire surface of the printed circuit board 30 to reflect leaking light toward the display panel 20, thereby improving the light efficiency of the display apparatus 1. The reflective sheet 45 may be coated with a high reflection coating agent (for example, silver, TiO₂) of a white or silver color. The reflective sheet 45 may include a reflective plate.

The optical member 50 may cause light radiated from the light source 40 and traveling toward the display panel 20 to have uniform brightness. Light of uniform brightness passed through the optical member 50 may be incident to the display panel 20. The optical member 50 may include a protective sheet 52 and a prism sheet 54. The optical member 50 may include at least one optical sheet.

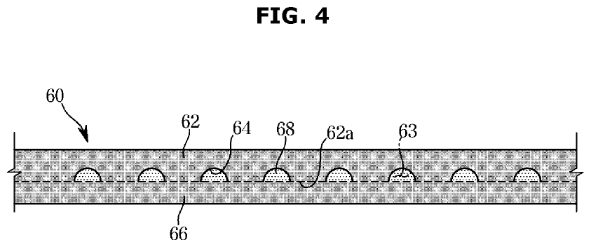

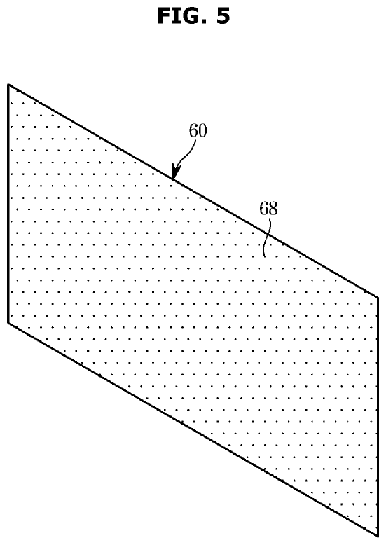

FIG. 4 is an enlarged cross-sectional view of a diffuser plate 60 of an optical member 50 of a display apparatus 1 according to an embodiment, and FIG. 5 is a perspective view of a diffuser plate 60 of an optical member 50 of a display apparatus 1 according to an embodiment.

The optical member 50 may include a diffuser plate 60.

The diffuser plate 60 may uniformly diffuse light exiting the light source 40 (direct type) or the light guide plate (edge type). The diffuser plate 60 may be a diffuser sheet. The diffuser plate 60 may correspond to a rear surface of the display panel 20. That is, the diffuser plate 60 may be positioned on the rear surface of the display panel 20 with a size corresponding to that of the rear surface of the display panel 20.

The diffuser plate 60 may include a first diffuser layer 62 and a second diffuser layer 66.

The first diffuser layer 62 may include a plurality of concave portions 63 on one surface. The second diffuser layer 66 may cover the one surface of the first diffuser layer 62 and the plurality of concave portions 63. In other words, the second diffuser layer 66 is disposed on the one surface of the first diffuser layer including the plurality of concave portions 63. The first and second diffuser layers 62 and 66 may be formed of the same material. That is, the first and second diffuser layers 62 and 66 may be formed of the same diffusion property to diffuse light supplied from the light source 40.

The diffuser plate 60 may include a light conversion member 68 (or light converter 68) provided in the plurality of concave portions 63.

The light conversion member 68 may convert a wavelength of light. The light conversion member 68 may include quantum dots (QDs). The light conversion member 68 may be positioned on a moving path of light in the diffuser plate 60 to convert a wavelength of the light from the light source 40. The light source 40 may include a blue light source that emits blue light. The light conversion member 68 may include QDs of a yellow color. Blue light emitted from the blue light source may pass through the QDs of the yellow color to be converted into white light.

QDs will be described below. When electrons receive energy, electrons that have been in a valence band are excited to a conduction band. Thereafter, the electrons lose energy to fall back to the valence band from the conduction band, and at this time, the electrons radiate the energy in the form of light. QDs generate strong fluorescence in a narrow wavelength band. QDs generate all colors of visible light according to the sizes. Also, because the QDs themselves generate natural colors, the QDs achieve a high color reproducibility without color loss. The QDs generate light of a shorter wavelength at smaller particles, and light of a longer wavelength at larger particles. The QDs may be a compound of cadmium selenide (Cdse), cadmium sulphide (Cds), cadmium telluride (Cdte), zinc selenide (Znse), zinc telluride (Znte), zinc selenide (Zns), etc.

The light conversion member 68 may be positioned in the plurality of concave portions 63. The plurality of concave portions 63 may be formed as empty spaces. The plurality of concave portions 63 may be formed as a plurality of concave surfaces 64 on one surface of the first diffuser layer 62. The sizes (the surface area or the volume) of the plurality of concave portions 63 may depend on depths of the plurality of concave surfaces 64 with respect to one surface of the first diffuser layer 62. The depths of the plurality of concave surfaces 64 may be smaller than a thickness of the first diffuser layer 62. The plurality of concave portions 63 may be covered by the second diffuser layer 66. The light conversion member 68 may be positioned in the plurality of concave portions 63, and surrounded by the plurality of concave surfaces 64 of the first diffuser layer 62 and one surface of the second diffuser layer 66. That is, the light conversion member 68 may be sealed by the first and second diffuser layers 62 and 66.

The plurality of concave surfaces 64 may include at least one of a polygonal flat surface or a curved surface. A shape of the plurality of concave surfaces 64 may be determined by a shape of a pattern protrusion 144 of a pattern roller 140 which will be described later. The plurality of concave portions 63 may be formed in the shape of a hemisphere as shown in FIG. 4, or in the shape of a polyhedron.

The light conversion member 68 may be arranged uniformly on the diffuser plate 60 (i.e., in a matrix form having an equidistance from one another). That is, the plurality of concave portions 63 on which the light conversion member 68 is arranged may also be arranged uniformly on the diffuser plate 60 having a constant distance amongst the adjacent concave portions 63. Through the configuration, uniform light conversion may be performed over the entire area of the display panel 20.

Hereinafter, a manufacturing apparatus for manufacturing the light diffusion plate 60 will be described.

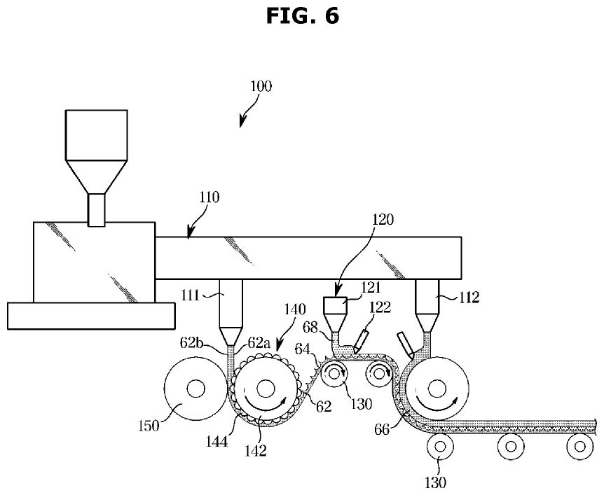

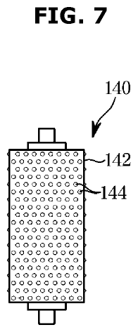

FIG. 6 shows an apparatus 100 for manufacturing a diffuser plate 60 of a display apparatus 1 according to an embodiment, and FIG. 7 shows a pattern roller 140 used in an apparatus for manufacturing a diffuser plate 60 of a display apparatus 1 according to an embodiment.

A manufacturing apparatus 100 may include an extrusion device 110 and a light conversion member supplying device 120.

The extrusion device 110 may extrude an optical resin and supply the extruded optical resin.

The extrusion device 110 may include a first extrusion portion 111 for forming the first diffusion layer 62 and a second extrusion portion 112 for forming the second diffusion layer 66. The first and second extrusion portions 111 and 112 may extend in one direction to correspond to a width in one direction of the diffuser plate 60. The first extrusion portion 111 may be positioned ahead of the second extrusion portion 112 in a manufacturing process. That is, the first and second extrusion portions 111 and 112 are arranged such that the first diffuser layer 62 may be extruded from the first extrusion portion 111 first, and then the second diffuser layer 66 may cover one surface of the first diffuser layer 62.

The light conversion member supplying device 120 may supply the light conversion member 68. The light conversion member supplying device 120 may include a supplier 121. The light conversion member 68 may be supplied to the plurality of concave portions 63 of the first diffusion layer 62 through the supplier 121. The supplier 121 may extend in one direction to correspond to the width in one direction of the diffuser plate 60 similar to the first and second extrusion portions 111 and 112.

The light conversion member supplying device 120 may be positioned between the first extrusion portion 111 and the second extrusion portion 112. The light conversion member supplying device 120 may supply the light conversion member 68 to the plurality of concave portions 63 of the first diffusion layer 62.

The light conversion member supplying device 120 may include a cleaning member 122. The cleaning member 122 may remove the light conversion member 68 excessively supplied to the plurality of concave portions 63 of the first diffusion layer 62 from the one surface of the first diffusion layer 62. That is, the cleaning member 122 may remove the excess light conversion member 68 remaining on the one surface of the first diffusion layer 62 after the light conversion member 68 is filled in the plurality of concave portions 63.

The manufacturing apparatus 100 may include a moving roller 130 and a pattern roller 140.

The moving roller 130 may move/guide the first diffusion layer 62 or the second diffusion layer 66. That is, the moving roller 130 may move or guide the diffuser plate 60 during a manufacturing process.

The pattern roller 140 may form the plurality of concave surfaces 64 in the first diffusion layer 62. That is, in the optical resin extruded and supplied by the first extrusion portion 111, the plurality of concave surfaces 64 may be formed by the pattern roller 140.

The pattern roller 140 may include a roller body 142 and a plurality of pattern protrusions 144 formed on an outer surface of the roller body 142. When the pattern roller 140 rotates, the roller body 142 may contact one surface of the first diffusion layer 62 so that the plurality of pattern protrusions 144 may press onto the one surface of the first diffusion layer 62 to form the plurality of concave portions 63 in the first diffusion layer 62. The plurality of pattern protrusions 144 may be arranged uniformly on the roller body 142.

A shape of the plurality of pattern protrusions 144 is not limited. In the embodiment, the plurality of pattern protrusions 144 may be formed in the shape of a hemisphere. However, the embodiment is not limited thereto. For example, the plurality of pattern protrusions 144 may be formed in the form of polyhedrons or include curved surfaces.

The manufacturing apparatus 100 may include a press roller 150.

The press roller 150 may be provided adjacent to the pattern roller 140. When the plurality of concave surfaces 64 are formed in one surface 62a of the first diffusion layer 62 by the pattern roller 140, the press roller 150 may support the other surface 62b of the first diffusion layer 62. Because the press roller 150 supports the other surface 62b of the first diffusion layer 62, the first diffusion layer 62 may be in close contact with the pattern roller 140.

Hereinafter, a method for manufacturing a diffuser plate 60 of the disclosure will be described.

An optical resin extruded by the first extrusion portion 111 of the extrusion device 110 may be supplied to the first pattern roller 140. The extruded optical resin may pass through the first pattern roller 140 to become the first diffusion layer 62 in which the plurality of concave surfaces 64 are formed. More specifically, the optical resin supplied from the first extrusion portion 111 may pass between the pattern roller 140 and the press roller 150 so that the plurality of concave portions 63 may be formed in the optical resin by the plurality of pattern protrusions 144 of the pattern roller 140.

On the first diffusion layer 62 in which the plurality of concave portions 63 are formed, separated from the pattern roller 140, the light conversion member 68 may be applied. That is, the light conversion member 68 may be filled into the plurality of concave portions 63. The supplier 121 of the light conversion member supplying apparatus 120 may supply the light conversion member 68 to the plurality of concave portions 63 of the first diffusion layer 62.

Therefore, the cleaning member 122 may remove the excess light conversion member remaining on the surface 62a of the first diffusion layer 62 except for the light conversion member 68 inserted in the plurality of concave portions 63.

An optical resin extruded from the second extrusion portion 112 may supply the second diffusion layer 66 to the one surface 62a of the first diffusion layer 62 to which the light conversion member 68 is supplied. The second diffusion layer 66 may cover the surface 62a of the first diffusion layer 62 and the light conversion member 68. The light conversion member 68 may be sealed by the first diffusion layer 62 and the second diffusion layer 66 through the process.

Through the process, the diffuser plate 60 including the first and second diffuser layers 62 and 66 and the light conversion member 68 may be manufactured.

According to an aspect of the disclosure, by positioning the QDs on the diffusion plate without adding a separate configuration for QDs, the configuration of the display apparatus may be simplified.

According to another aspect of the disclosure, by preventing the QDs from being exposed to the outside, distortion of the QDs may be reduced.

According to another aspect of the disclosure, by improving the structure of the diffuser plate, a color reproducibility may be improved.

Although embodiments of the disclosure have been shown and described, it would be appreciated by those skilled in the art that changes may be made in these embodiments without departing from the principles and spirit of the disclosure, the scope of which is defined in the claims and their equivalents.

What is claimed is:

1. A display apparatus comprising:
a display panel;
a light source configured to supply light to the display panel; and
a diffuser plate configured to diffuse the light supplied to the display panel,
wherein the diffuser plate comprises:
a first diffusion layer comprising a plurality of concave portions in a first surface of the first diffusion layer;
a light converter provided in each concave portion of the plurality of concave portions; and
a second diffusion layer configured to cover the first surface of the first diffusion layer.

2. The display apparatus according to claim 1, wherein the light converter in the plurality of concave portions is surrounded by the first diffusion layer and the second diffusion layer.

3. The display apparatus according to claim 2, wherein:
the plurality of concave portions comprise a plurality of concave surfaces, and
the light converter is sealed by the plurality of concave surfaces and a second surface of the second diffusion layer opposite to the first surface of the first diffusion layer.

4. The display apparatus according to claim 1, wherein the light converter is arranged uniformly on the diffuser plate.

5. The display apparatus according to claim 1, wherein a material of the first diffusion layer is identical to a material of the second diffusion layer.

6. The display apparatus according to claim 1, wherein the diffuser plate corresponds to a rear surface of the display panel.

7. The display apparatus according to claim 1, wherein the plurality of concave portions are formed when the first surface of the first diffusion layer is pressed by a pattern roller, the pattern roller comprising a plurality of pattern protrusions formed on an outer surface of the pattern roller.

8. The display apparatus according to claim 7, wherein a depth of a concave portion of the plurality of concave portions is smaller than a depth of the first diffusion layer.

9. The display apparatus according to claim 3, wherein each concave surface of the plurality of concave surfaces comprises at least one of a polygonal flat surface or a curved surface.

10. The display apparatus according to claim 1, wherein:
the light source is configured to emit blue light, and
the light converter comprises quantum dots (QDs) configured to convert the blue light into white light.

11. The display apparatus according to claim 1, wherein:
the light source comprises a plurality of light sources arranged on a plane extending parallel to a rear surface of the display panel, and
the diffuser plate is positioned between the display panel and the plurality of light sources.

12. The display apparatus according to claim 1, further comprising a light guide plate configured to receive the light supplied from the light source from a light receiving surface of the light guide plate and configured to emit the light through a light emitting surface,
wherein the diffuser plate is provided on an opposite side to the light emitting surface of the light guide plate.

13. A display apparatus comprising:
a display panel;
a plurality of light sources arranged to correspond to a rear surface of the display panel and configured to supply light to the display panel; and
a diffuser plate positioned between the display panel and the plurality of light sources and configured to diffuse the light supplied to the display panel,
wherein the diffuser plate comprises:
a first diffusion layer and a second diffusion layer stacked on each other; and
a light converter positioned between the first diffusion layer and the second diffusion layer.

14. The display apparatus according to claim 13, wherein:
the first diffusion layer comprises a plurality of concave surfaces arranged in a first surface of the first diffusion layer, and
the light converter is surrounded by each concave surface of the plurality of concave surfaces and the second diffusion layer.

15. The display apparatus according to claim 14, wherein the plurality of concave surfaces and the light converter are arranged uniformly on the diffuser plate.

16. A display apparatus comprising:
a diffuser plate comprising:
a first diffusion layer comprising a plurality of concave portions in a first surface of the first diffusion layer;
a light converter provided in each concave portion of the plurality of concave portions; and
a second diffusion layer provided on the first surface of the first diffusion layer,
wherein the plurality of concave portions are provided on a single plane.

17. The display apparatus according to claim 16, wherein the light converter in the plurality of concave portions is sealed by the first diffusion layer and the second diffusion layer.

18. The display apparatus according to claim 16, wherein a material of the first diffusion layer is identical to a material of the second diffusion layer.

19. The display apparatus according to claim 16, wherein:
the plurality of concave portions comprise a plurality of concave surfaces, and
each concave surface of the plurality of concave surfaces comprises at least one of a polygonal flat surface or a curved surface.
